(19) United States
(12) Patent Application Publication
(10) Pub. No.: US 2026/0257732 A1
(43) Pub. Date: Sep. 3, 2026

(54) Splash Shields for Use in Protecting Air Conditioning Modules in Vehicles

(71) Applicant: Nissan North America, Inc., Franklin, TN (US)

(72) Inventors: Cassidy Marie Walsh, Royal Oak, MI (US); Brian Haupt, Farmington Hills, MI (US); NandaKishore Burri, Farmington Hills, MI (US)

(21) Appl. No.: 19/066,769

(22) Filed: Feb. 28, 2025

(51) Int. Cl. B62D 25/18; B60H 1/00; B62D 21/03; B62D 25/20

(52) U.S. Cl. CPC B62D 25/18; B60H 1/00535; B62D 21/03; B62D 25/20

(57) ABSTRACT

A vehicle that includes: a chassis; a floor panel that is connected to the chassis; an air conditioning module that extends through the floor panel; a guard-drafter that is connected to the floor panel; and a splash shield that is connected to and which extends between the chassis and the guard-drafter. The splash shield is configured to at least partially conceal (e.g., cover) and thereby protect the air conditioning module from tiresplash in order to inhibit corrosion thereof.

### TECHNICAL FIELD

The present application relates to splash shields that inhibit the corrosion of air conditioning (AC) modules in vehicles by protecting the AC modules from tiresplash.

### BACKGROUND

Modern vehicles often include multiple AC modules in different sections thereof. For example, many vehicles include a front AC module to condition a front section of the passenger seating area and a rear AC module to condition a rear section of the passenger seating area, which is often connected to and extends through and beneath the floor panel.

In order to inhibit corrosion of the rear AC module in such vehicles, the present disclosure provides a splash shield that (partially or entirely) conceals and protects the rear AC module (e.g., from tiresplash, debris, sand, salt, etc.).

### SUMMARY

In one aspect of the present disclosure, a vehicle is disclosed that includes: a chassis; a floor panel that is connected to the chassis; a vehicle body that is connected to the floor panel; a guard-drafter that is connected to the floor panel; and a splash shield that is connected to and which extends between the chassis and the guard-drafter.

In certain embodiments, the vehicle may further include rear wheels that are supported by the chassis.

In certain embodiments, the guard-drafter and the splash shield may be positioned rearwardly of the rear wheels.

In certain embodiments, the splash shield may be positioned inboard of the rear wheels.

In certain embodiments, the vehicle may further include a wheel liner that is positioned between the rear wheels and the vehicle body.

In certain embodiments, the guard-drafter and the splash shield may be positioned rearwardly of the wheel liner.

In certain embodiments, the vehicle may further include an air conditioning module that extends through the floor panel.

In certain embodiments, the floor panel may define a window that is configured to receive the air conditioning module.

In certain embodiments, the splash shield may be configured to at least partially conceal the air conditioning module to inhibit corrosion thereof.

In certain embodiments, the chassis may include a first longitudinal support and a second longitudinal support, each of which extends along a length of the vehicle, and a crossbeam, which extends between the first longitudinal support and the second longitudinal support.

In certain embodiments, the splash shield may be connected to the first longitudinal support via a first fastener.

In certain embodiments, the splash shield may be connected to the guard-drafter via a second fastener that extends in generally orthogonal relation to the first fastener.

In another aspect of the present disclosure, a vehicle is disclosed that includes: a chassis; a floor panel that is connected to the chassis; an air conditioning module that extends through the floor panel; and a splash shield that is connected to the chassis. The splash shield is configured to at least partially conceal the air conditioning module and protect the air conditioning module from tiresplash.

In certain embodiments, the splash shield may include: an upper panel; a lower panel that extends from the upper panel; and a side panel that extends outboard from at least one of the upper panel and the lower panel.

In certain embodiments, the splash shield may further include a shoulder that extends inboard from the upper panel and which is configured to deflect tiresplash.

In certain embodiments, the upper panel and the lower panel may extend in non-parallel relation.

In certain embodiments, the splash shield may further include a ridge that is positioned at an intersection of the upper panel and the lower panel.

In certain embodiments, the lower panel may extend from the upper panel at a first angle that lies substantially within the range of approximately 340 degrees to approximately 350 degrees.

In certain embodiments, the side panel may extend from the upper panel and/or the lower panel at a second angle that lies substantially within the range of approximately 300 degrees to approximately 330 degrees.

In another aspect of the present disclosure, a vehicle is disclosed that includes: a chassis; rear wheels that are supported by the chassis; a floor panel that is connected to the chassis and which defines a window that extends therethrough; an air conditioning module that is connected to the floor panel such that the air conditioning module extends through the window; a vehicle body that is connected to the floor panel; a guard-drafter that is connected to the floor panel; and a splash shield that is configured to at least partially cover the air conditioning module to inhibit corrosion thereof as a result of tiresplash from the rear wheels.

The chassis includes a first longitudinal support and a second longitudinal support, each of which extends along a length of the vehicle, and a crossbeam, which extends between the first longitudinal support and the second longitudinal support.

The splash shield includes: an upper panel; an upper flange that extends from the upper panel and which is connected to the first longitudinal support; a lower panel that extends from the upper panel at a first angle that lies substantially within the range of approximately 340 degrees to approximately 350 degrees; a side panel that extends outboard from at least one of the upper panel and the lower panel at a second angle that lies substantially within the range of approximately 300 degrees to approximately 330 degrees; and a lower flange that extends from the lower panel and which is connected to the guard-drafter.

In certain embodiments, the splash shield may further include at least one rib that extends between the upper flange and the lower flange.

In certain embodiments, the splash shield may further include a stabilizer that extends into the first longitudinal support to inhibit movement of the splash shield in relation to the chassis and the guard-drafter.

### BRIEF DESCRIPTION OF THE DRAWINGS

According to common practice, certain components, elements, and/or features may be omitted from certain drawings in the interest of clarity.

FIG. 1 is a partial, bottom, perspective view of the rear-end of a vehicle that includes a splash shield according to the principles of the present disclosure.

FIG. 2 is a partial, side, perspective view of the vehicle illustrating a guard-drafter and connection of the splash shield thereto.

FIG. 3 is a partial, top, perspective view of the vehicle illustrating connection of the splash shield to the guard-drafter and a chassis of the vehicle.

FIG. 4 is a partial, bottom, perspective view of the vehicle illustrating connection of the splash shield to the guard-drafter and to the chassis.

FIG. 5 is a partial, side, plan view of the vehicle illustrating connection of the splash shield to the guard-drafter and the chassis such that the splash shield covers an AC module of the vehicle.

FIG. 6 is a cross-sectional view taken through line 6-6 in FIG. 5.

FIG. 7 is a cross-sectional view taken through line b in FIG. 5.

FIG. 8 is an enlargement of the area of detail indicated in FIG. 5.

### DETAILED DESCRIPTION

The present disclosure describes a splash shield that (partially or entirely) covers and protects the (rear) air conditioning module in a vehicle to inhibit the corrosion thereof that might otherwise occur as a result of tiresplash from the rear wheels, particularly in environments where the use of salt on the roadways is more common.

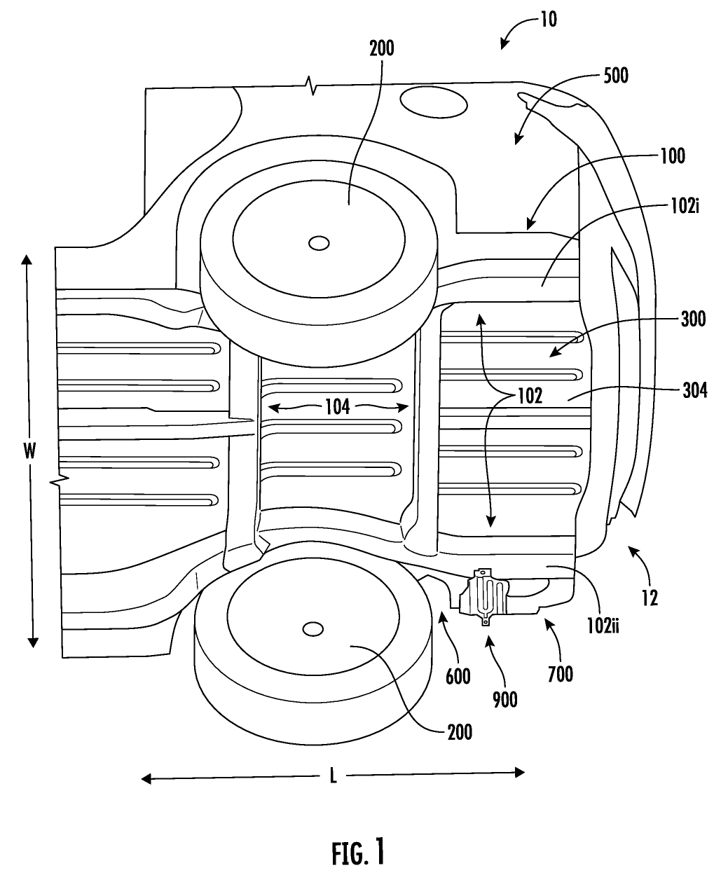

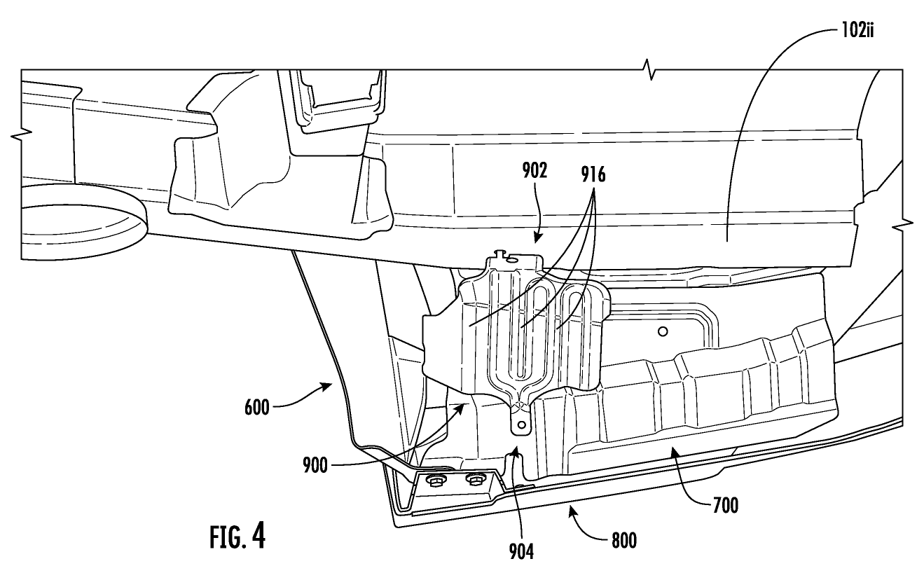

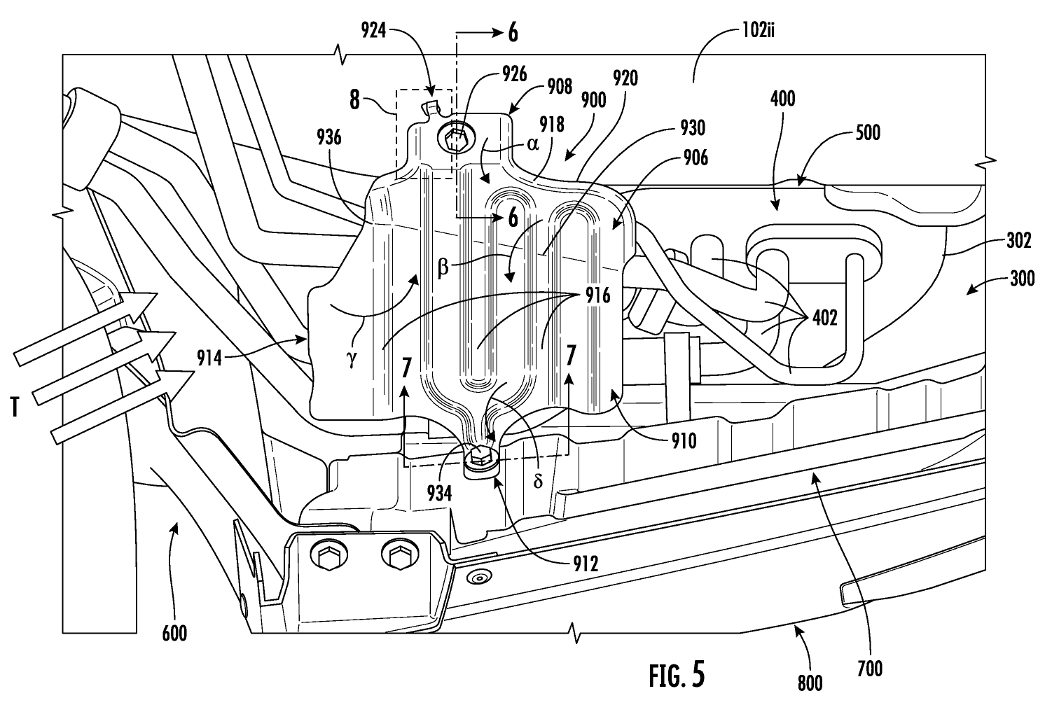

With reference to FIGS. 1-5, a vehicle 10 is disclosed that includes: a chassis 100; rear wheels 200, which are connected (secured) to (or otherwise supported by) the chassis 100; a floor panel 300; an AC module 400 (FIG. 5); a vehicle body 500, which is connected (secured) to the floor panel 300; a wheel liner 600, which is positioned (located) between the rear wheels 200 and the vehicle body 500 and is configured to reduce tiresplash T (FIG. 5) (e.g., from the rear wheels 200); a guard-drafter 700; a rear facia 800 (FIGS. 4, 5), which is connected (secured) to (or otherwise supported by) the guard-drafter 700; and a splash shield 900. Although generally illustrated and described in the context of a passenger vehicle, it should be appreciated that the principles of the present disclosure may be applied to a wide variety of vehicles (e.g., trucks, SUVs, vans, buses, boats, airplanes, trains, etc.).

The chassis 100 supports the vehicle load and includes longitudinal supports 102, which extend axially along a length L of the vehicle 10, and crossbeams 104, which connect and extend laterally between the longitudinal supports 102 along a width W of the vehicle 10 in generally orthogonal relation to the longitudinal supports 102. More specifically, the chassis 100 includes a (first, driver side) longitudinal support 102i and a (second, passenger side) longitudinal support 102ii.

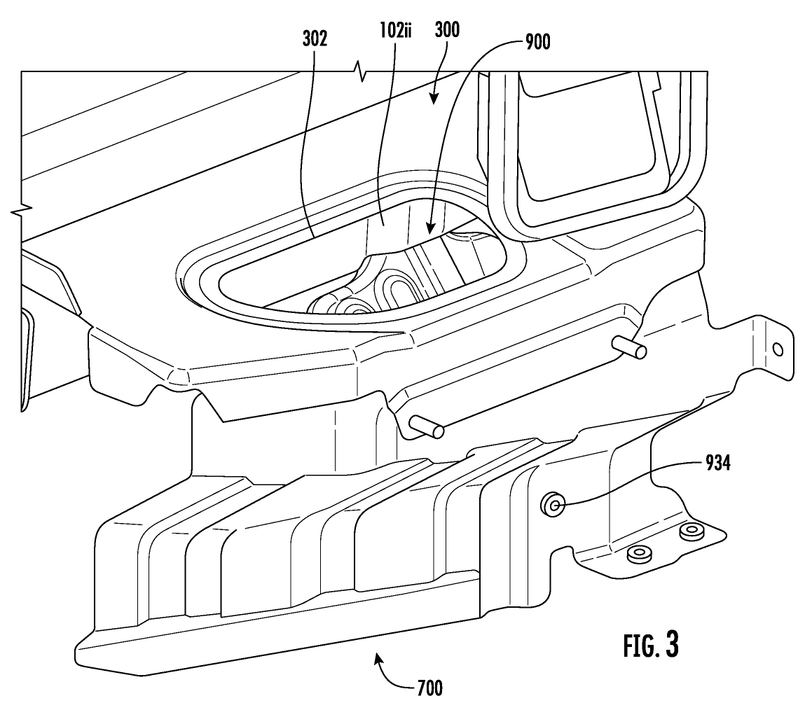

The floor panel 300 is connected to the chassis 100 (e.g., to the longitudinal supports 102 and/or to the crossbeams 104) and defines a window 302 (FIGS. 3, 5) that extends therethrough, which is configured to receive the AC module 400, as described in further detail below. More specifically, the longitudinal supports 102 and the crossbeams 104 are connected (secured) to an underside (bottom surface) 304 of the floor panel 300 so as to increase the strength (e.g., the rigidity) of the floor panel 300 and the vehicle 10.

The AC module 400 (FIG. 5) is positioned (located) in a rear-end 12 of the vehicle 10 and includes a variety of components (e.g., coolant lines 402, seals, joints, etc.). More specifically, the AC module 400 is positioned (located) rearwardly of the rear wheels 200 and is connected (secured) to the floor panel 300 such that the AC module 400 extends through and beneath the floor panel 300 via the window 302.

The guard-drafter 700 is connected (secure) to the floor panel 300, as seen in FIG. 3, and is positioned (located) rearwardly of both the rear wheels 200 and the wheel liner 600. In addition to supporting the rear facia 800, the guard-drafter 700 prevents exhaust from entering the vehicle 10 and inhibits heat distribution from the exhaust system to the rear facia 800.

With reference now to FIGS. 4 and 5 in particular, the splash shield 900 will be discussed. The splash shield 900 performs multiple functions in the vehicle. For example, the splash shield 900 extends the functionality of the wheel liner 600 (FIGS. 1, 4) and is configured to deflect tiresplash T (FIG. 5) in order to reduce (if not entirely prevent) tiresplash T (FIG. 5) from contacting and/or collecting on the AC module 400 (e.g., the coolant lines 402), thereby inhibiting (if not entirely preventing) the corrosion thereof that might otherwise occur. Additionally, the splash shield 900 increases the aerodynamics of the vehicle 10 by redirecting and accelerating airflow in order to create negative pressure around the AC module 400, and stabilizes the rear facia 800 by inhibiting (if not entirely preventing) vibration and/or rattle thereof.

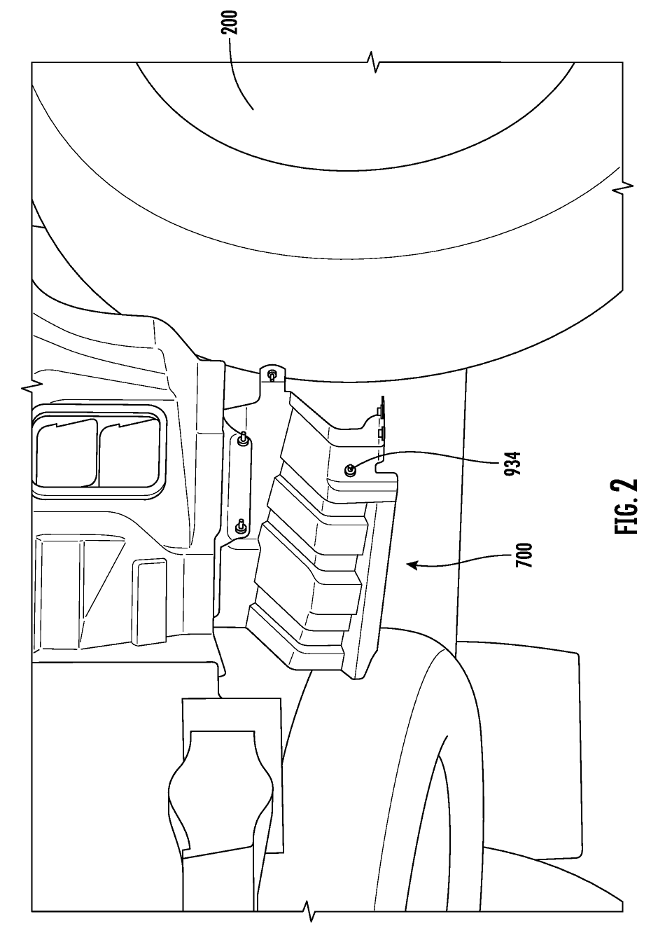

The splash shield 900 is connected (secured) to and extends between the chassis 100 (e.g., the longitudinal support 102ii) and the guard-drafter 700 such that the splash shield 900 connects the guard-drafter 700 and, thus, the rear facia 800 to the chassis 100, thereby stabilizing the rear facia 800, as indicated above. More specifically, the splash shield 900 is positioned inboard of the rear wheels 200 and rearwardly of both the rear wheels 200 and the wheel liner 600, as seen in FIGS. 1 and 2.

In the illustrated embodiment, the vehicle 10 is configured such that the splash shield 900 is connected (secured) to the longitudinal support 102ii. Embodiments in which the splash shield 900 may be connected (secured) to the longitudinal support 102i are also envisioned herein, however (e.g., depending upon the specific position (location) of the AC module 400.

The splash shield 900 is configured to at least partially conceal (e.g., cover) the AC module 400 and thereby protect the AC module 400 from tiresplash T (FIG. 5) in order to inhibit (if not entirely prevent) the corrosion thereof, as indicated above. The splash shield 900 includes: respective upper and lower ends 902. 904; an upper panel 906; an upper flange 908, which is positioned (located) at the upper end 902 of the splash shield 900; a lower panel 910; a lower flange 912, which is positioned (located) at the lower end 904 of the splash shield 900; a side panel 914; and (one or more) at least one rib 916.

The splash shield 900 may be formed from any material or combination of materials suitable for the intended purposes discussed above. For example, in the illustrated embodiment, the splash shield 900 is formed from sheet metal having a thickness that lies substantially within the range of approximately 1.6mm to approximately 2.0mm and includes a heat-resistant coating. Embodiments in which the splash shield 900 may be non-metallic in construction are also envisioned herein, however.

The upper panel 906 includes a shoulder 918 that extends along a periphery 920 thereof, either partially or entirely. The shoulder 918 extends inboard from the upper panel 906 (i.e., away from the guard-drafter 700) and is configured to deflect tiresplash T (FIG. 5) in order to further reduce (if not entirely prevent) tiresplash T (FIG. 5) from contacting and/or collecting on the AC module 400. It is also envisioned that the shoulder 918 may be configured to increase the strength (e.g., the rigidity) of the upper panel 906 and, thus, the splash shield 900 (e.g., in order to further increase the aerodynamics of the vehicle 10 and/or inhibit (if not entirely prevent) vibration, rattle, and/or flexure of the splash shield 900).

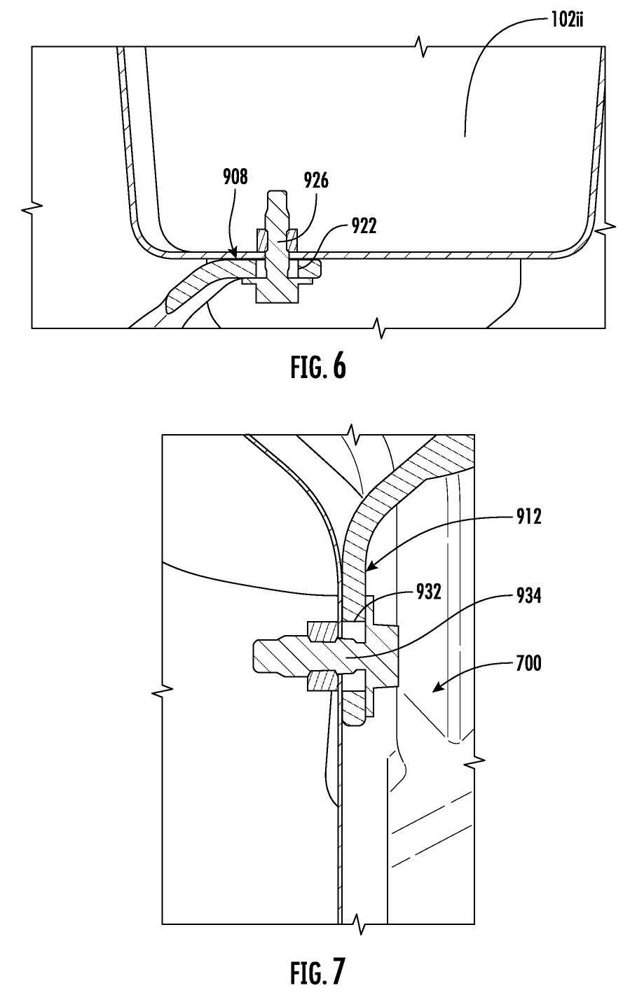

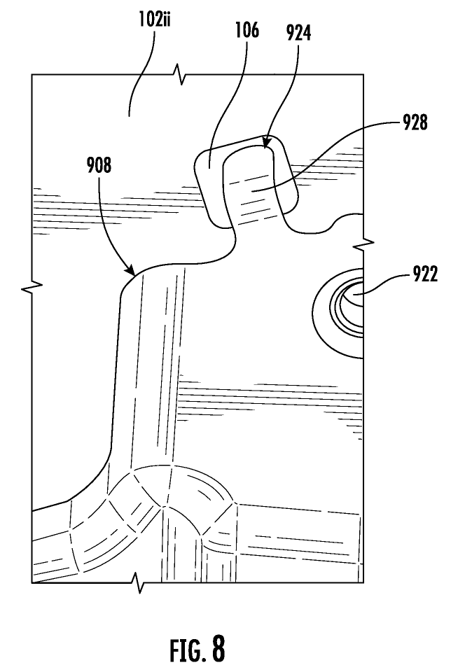

The upper flange 908 extends from the upper panel 906 at a (first) obtuse angle α, which lies substantially within the range of approximately 120 degrees to approximately 145 degrees, and includes a (first) opening 922 (FIGS. 6, 8) and a stabilizer 924.

The opening 922 receives a (first) fastener 926 (FIG. 5, 6) such that the fastener 926 extends through the upper flange 908 and into the longitudinal support 102ii, thereby connecting the upper flange 908 and, thus, the splash shield 900 to the chassis 100.

The stabilizer 924 includes a finger 928 that extends outwardly from the upper flange 908 and into an aperture 106 in the longitudinal support 102ii. Positioning of the finger 928 within the aperture 106 inhibits (if not entirely prevents) movement (e.g., rotation, twisting) of the splash shield 900 (e.g., in relation to the chassis 100 and/or the guard-drafter 700).

The lower panel 910 extends from the upper panel 906 in non-parallel relation so as to define a ridge 930 at the intersection thereof, which further increases the strength (e.g., the rigidity) of the splash shield 900 (e.g., in order to further increase the aerodynamics of the vehicle 10 and/or inhibit (if not entirely prevent) vibration, rattle, and/or flexure of the splash shield 900) and facilitates connection of the splash shield 900 to the guard-drafter 700 and the longitudinal support 102ii. More specifically, the lower panel 910 extends from the upper panel 906 at a (second) obtuse angle β, which is defined by the ridge 930 and lies substantially within the range of approximately 340 degrees to approximately 350 degrees.

The lower flange 912 extends from the lower panel 910 at a (third) obtuse angle δ, which is substantially similar (if not identical) to the angle α and, thus, lies substantially within the range of approximately 120 degrees to approximately 145 degrees.

The lower flange 912 includes a (second) opening 932 (FIG. 7), which receives a (second) fastener 934 (FIGS. 2, 3, 5, 7) such that the fastener 934 extends through the lower flange 912 and into the guard-drafter 700, thereby connecting the lower flange 912 and, thus, the splash shield 900 to the guard-drafter 700. As seen in FIGS. 6 and 7, the splash shield 900 is configured such that the flanges 908, 912 extend in generally orthogonal (perpendicular) relation, whereby the fastener 934 extends in generally orthogonal (perpendicular) relation to the fastener 926.

The side panel 914 extends outboard from at least one of the respective upper and lower panels 906, 910 (i.e., towards the guard-drafter 700) and is configured to deflect tiresplash T (FIG. 5) in order to further reduce (if not entirely prevent) tiresplash T (FIG. 5) from contacting and/or collecting on the AC module 400. More specifically, in the illustrated embodiment, the side panel 914 extends from each of the respective upper and lower panels 906, 910 at a (fourth) obtuse angle γ, which lies substantially within the range of approximately 300 degrees to approximately 330 degrees. Embodiments in which the side panel 914 may extend from either the upper panel 906 or the lower panel 910 are also envisioned herein, however (e.g., depending upon the particular configuration and/or the particular location of the AC module 400, the particular configuration of the chassis 100, etc.).

As seen in FIG. 5, the upper panel 906, the lower panel 910, and the side panel 914 intersect at a corner 936, which further increases the strength (e.g., the rigidity) of the splash shield 900 (e.g., in order to further increase aerodynamics and/or inhibit (if not entirely prevent) vibration, rattle, and/or flexure thereof).

The rib(s) 916 extend between the respective upper and lower ends 902, 904 of the splash shield 900 in generally vertical orientations and further increase the strength (e.g., the rigidity) of the splash shield 900 (e.g., in order to further increase aerodynamics and/or inhibit (if not entirely prevent) vibration, rattle, and/or flexure thereof). More specifically, in the illustrated embodiment, the rib(s) 916 extend between the respective upper and lower flanges 908, 912, as seen in FIGS. 4 and 5.

Although shown as including a plurality of ribs 916, which attribute a corrugated configuration to the splash shield 900, embodiments in which the splash shield 900 may include a single rib 916 are also envisioned herein.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180° ± 25% (i.e., an angle that lies within the range of (approximately) 135° to (approximately) 225°) and the term “generally orthogonal” should be understood as referring to configurations in with the pertinent components are oriented so as to define an angle therebetween that is equal to 90° ± 25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a chassis;
a floor panel connected to the chassis;
a vehicle body connected to the floor panel;
a guard-drafter connected to the floor panel; and
a splash shield connected to and extending between the chassis and the guard-drafter.

2. The vehicle of claim 1, further comprising:
rear wheels supported by the chassis, wherein the guard-drafter and the splash shield are positioned rearwardly of the rear wheels.

3. The vehicle of claim 2, wherein the splash shield is positioned inboard of the rear wheels.

4. The vehicle of claim 2, further comprising:
a wheel liner positioned between the rear wheels and the vehicle body.

5. The vehicle of claim 4, wherein the guard-drafter and the splash shield are positioned rearwardly of the wheel liner.

6. The vehicle of claim 1, further comprising:
an air conditioning module extending through the floor panel.

7. The vehicle of claim 6, wherein the floor panel defines a window configured to receive the air conditioning module.

8. The vehicle of claim 6, wherein the splash shield is configured to at least partially conceal the air conditioning module to inhibit corrosion thereof.

9. The vehicle of claim 1, wherein the chassis includes:
a first longitudinal support and a second longitudinal support each extending along a length of the vehicle; and
a crossbeam extending between the first longitudinal support and the second longitudinal support.

10. The vehicle of claim 9, wherein the splash shield is connected to the first longitudinal support via a first fastener and to the guard-drafter via a second fastener extending in generally orthogonal relation to the first fastener.

11. A vehicle comprising:
a chassis;
a floor panel connected to the chassis;
an air conditioning module extending through the floor panel; and
a splash shield connected to the chassis, wherein the splash shield is configured to at least partially conceal the air conditioning module and protect the air conditioning module from tiresplash.

12. The vehicle of claim 11, wherein the splash shield includes:
an upper panel;
a lower panel extending from the upper panel; and
a side panel extending outboard from at least one of the upper panel and the lower panel.

13. The vehicle of claim 12, wherein the splash shield further includes:
a shoulder extending inboard from the upper panel and configured to deflect tiresplash.

14. The vehicle of claim 12, wherein the upper panel and the lower panel extend in non-parallel relation.

15. The vehicle of claim 14, wherein the splash shield further includes:
a ridge positioned at an intersection of the upper panel and the lower panel.

16. The vehicle of claim 15, wherein the lower panel extends from the upper panel at a first angle substantially within a range of approximately 340 degrees to approximately 350 degrees.

17. The vehicle of claim 16, wherein the side panel extends from the upper panel and/or the lower panel at a second angle substantially within a range of approximately 300 degrees to approximately 330 degrees.

18. A vehicle comprising:
a chassis including:
a first longitudinal support and a second longitudinal support each extending along a length of the vehicle; and
a crossbeam extending between the first longitudinal support and the second longitudinal support;
rear wheels supported by the chassis;
a floor panel connected to the chassis, wherein the floor panel defines a window extending therethrough;
an air conditioning module connected to the floor panel such that the air conditioning module extends through the window;
a vehicle body connected to the floor panel;
a guard-drafter connected to the floor panel; and
a splash shield configured to at least partially cover the air conditioning module to inhibit corrosion thereof as a result of tiresplash from the rear wheels, wherein the splash shield includes:
an upper panel;
an upper flange extending from the upper panel and connected to the first longitudinal support;
a lower panel extending from the upper panel at a first angle substantially within a range of approximately 340 degrees to approximately 350 degrees;
a side panel extending outboard from at least one of the upper panel and the lower panel at a second angle substantially within a range of approximately 300 degrees to approximately 330 degrees; and
a lower flange extending from the lower panel and connected to the guard-drafter.

19. The vehicle of claim 18, wherein the splash shield further includes:
at least one rib extending between the upper flange and the lower flange.

20. The vehicle of claim 18, wherein the splash shield further includes:
a stabilizer extending into the first longitudinal support to inhibit movement of the splash shield in relation to the chassis and the guard-drafter.
